(19) United States
(12) Patent Application Publication
(10) Pub. No.: US 2026/0019248 A1
(43) Pub. Date: Jan. 15, 2026

(54) KEY GENERATION IN TRUSTED EXECUTION ENVIRONMENTS

(71) Applicant: Magic Labs, Inc., San Francisco, CA (US)

(72) Inventors: Fei-Yang Jen, New York, NY (US); Sungcheul Hong, New York, NY (US); Jaemin Jin, New York, NY (US); Yi Wei Chen, San Francisco, CA (US); Karl Jin, Chicago, IL (US)

(21) Appl. No.: 19/267,224

(22) Filed: Jul. 11, 2025

Related U.S. Application Data
(60) Provisional application No. 63/671,504, filed on Jul. 15, 2024.

(51) Int. Cl. H04L 9/08

(52) U.S. Cl. CPC H04L 9/0877; H04L 9/0894

(57) ABSTRACT

A key management system uses a trusted execution environment (TEE) to generate a private key for a user. The key management system is used to provide network users with a non-custodial wallet, or self-custody wallet, in a safe and secure manner. The key management system provides services to network users including creation of a user's digital wallet, processing of transactions conducted by the user's digital wallet, and recovery process steps to recover the user's digital wallet. Secure applications are provided by the key management system within the TEE. The TEE may be accessible via cloud services as a separate virtual machine being an isolated partition and/or execution environment. All services provided by the key management system are performed within the TEE to ensure data privacy and security. The TEE uses sharding algorithms on private keys generated by users and distributes shards of the private keys on the key management system.

### CROSS REFERENCE TO RELATED APPLICATIONS

This application claims the benefit of U.S. Provisional Patent App. No. 63/671,504, filed Jul. 15, 2024, the disclosure of which is hereby incorporated by reference herein.

### TECHNICAL FIELD

This disclosure relates generally to systems, methods, and computer readable media to perform digital key and digital wallet management and, more specifically, digital key and digital wallet management using a trusted execution environment (TEE).

### BACKGROUND

A digital wallet designed for blockchain use may be used to store cryptocurrencies and manage cryptographic keys. Unlike traditional wallets, blockchain wallets eliminate the need for intermediaries, giving users full control over their funds. Users may download digital wallets from various providers, including exchanges, hardware wallets, and software wallets. Digital wallets may be provided to users using a non-custodial approach. A non-custodial wallet, or self-custody wallet, puts the user in full control of managing their wallet and funds thereon.

What is needed is an improved system for the secure management of non-custodial digital wallets and associated private key data.

### BRIEF DESCRIPTION OF THE DRAWINGS

FIG. 1 depicts a block diagram of a key generation system using a trusted execution environment, according to one or more disclosed embodiments.

FIG. 2 depicts an exemplary process flow of a digital wallet creation process using a trusted execution environment, according to one or more disclosed embodiments.

FIG. 3 depicts an exemplary process flow of a digital transaction process using a trusted execution environment, according to one or more disclosed embodiments.

FIG. 4 depicts an exemplary process flow of a digital wallet recovery process using a trusted execution environment, according to one or more disclosed embodiments.

FIG. 5 depicts, in block diagram form, a simplified system diagram for an electronic device in accordance with one or more disclosed embodiments.

### DETAILED DESCRIPTION

### Exemplary Key Generation System and Architecture

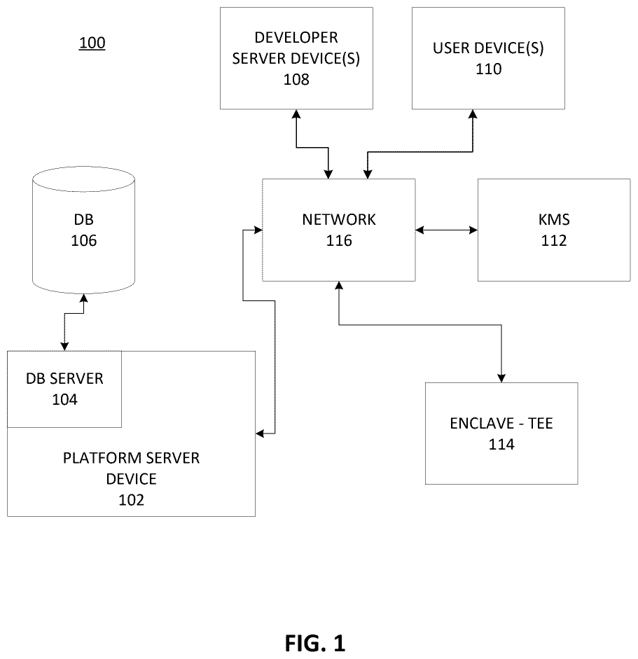

FIG. 1 is a block diagram of a key generation system. Block diagram 100 of FIG. 1 includes platform server device 102, database server 104, database 106, developer server device(s) 108, user device(s) 110, key management system (KMS) 112, a trusted execution environment (TEE) 114 (also referred to herein as an “enclave” or “secure enclave”), and a network 116.

In some embodiments, platform server device 102 may include a database server 104 that may be communicatively coupled to a database 106 that stores data. In one embodiment, database 106 may be a local storage device. In another embodiment, database 106 may be a remote storage device, such as cloud storage, or the like. Platform server device 102 may be in communication with a plurality of user device(s) 110. Platform server device 102 may also be in communication with developer server device(s) 108, KMS 112 and TEE 114.

In some embodiments, user device(s) 110 may be computers that include a web browser, or a software application used to access remote computer devices, such as platform server device 102. User device(s) 110 may access remote computer devices using the Internet or another network 116. More specifically, user device(s) may be communicatively coupled with platform server device 102 through many network 116 interfaces including, but not limited to, at least one of the Internet, a local area network (LAN), a wide area network (WAN), a cellular network, a cable modem, or the like. User device(s) 110 may be any device capable of accessing the Internet including, but not limited to, a desktop computer, a laptop computer, a smartphone, a tablet, a smart watch, or other web-based connectable equipment or mobile devices. User device(s) 110 may include GPS sensors, accelerometers, and/or a gyroscope that may be used to collect a device user's biometric data, location data, etc. Other data pertaining to the device user may include, for example, user identification information, metadata, and other data associated with the user of the overall system.

Platform server device 102, developer server device(s) 108, and user device(s) 110 may be used with a variety of different third-party systems to provide the disclosed key generation system. The modules discussed are exemplary, and other types of third-party systems are intended to be compatible with platform server device 102, developer server device(s) 108, and user device(s) 110. Platform server device 102 may include an API to interface with third party systems, such as KMS 112, TEE 114, or the like. In some embodiments, platform server device 102 may include an API to interface with one or more developer server device(s) 108. In operation, a user at user device 110 may perform actions (e.g., wallet generation, digital transactions, wallet recovery) through platform server device 102. Additionally, or alternatively, the user at user device 110 may perform actions through platform server device 102 via one or more developer server device(s) 108. Platform server device 102 may then communicate with one or more third party systems, such as KMS 112, TEE 114, or the like, to perform the actions as described herein.

### Exemplary Key Generation System and Architecture

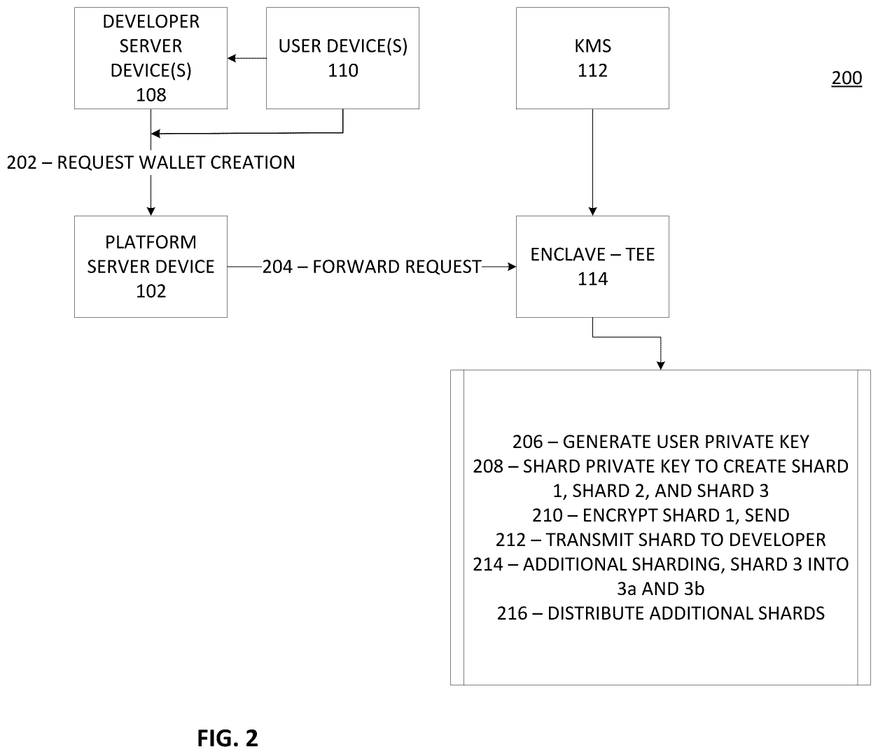

FIG. 2 illustrates a process 200 for generating a private key for a user using a trusted execution environment (TEE). FIG. 2 includes developer server device(s) 108, user device 110, platform server device 102, KMS 112, and TEE 114. A new wallet creation request may be initiated by a user at user device 110. Additionally, or alternatively, the new wallet creation request may be initiated by another user at one of developer server device(s) 108. A request 202 to create a new digital wallet may be transmitted from either developer server device(s) 108, the user device 110, or a combination thereof, to platform server device 102. The platform server device 102 may, in some embodiments, authenticate the user. For example, user authentication may include sending an email to an email account associated with the user that initiated request 202. Request 202 may include encryption context, such as a hashed user passcode (e.g., a PIN that only the user knows), KMS instance data, network data (e.g., the Ethereum Mainnet or “ETH_MAINNET”), and metadata (e.g., wallet_group_id).

After authenticating the user, platform server device 102 may forward 204 the request to TEE 114. The forwarded request may include, for example, encryption context, such as the hashed user passcode (e.g., a PIN that only the user knows) and network data (e.g., ETH_MAINNET). It is understood that other networks may be used, and the disclosed implementation example is not meant to be limiting. For example, any blockchain network compatible with the Ethereum Virtual Machine (EVM chain).

After receiving the forwarded request, TEE 114 generates 206 a private key for the user. The private key may be generated on a supplied network, such as ETH_MAINNET for example. The generated private key may then be sharded using a sharding algorithm. An example sharding algorithm is Shamir Secret Sharding (SSS) described herein. TEE 114 may shard 208 the private key using SSS to create three shards (e.g., Shard 1, Shard 2, Shard 3). To reassemble the private key, at least two of the three shards would be needed. Once sharding is complete, TEE 114 may encrypt 210 Shard 1. Shard 1 may be encrypted using data from KMS 112. Encrypted Shard 1 may be stored by platform server device 102 in a database, such as database 106, or within a secure cloud storage location. Shard 1 may be combined with Shard 3, for example, to access the user's digital wallet for day-to-day transactions as well as for wallet recovery procedures. TEE 114 may transmit Shard 2 to a developer, such as developer server device(s) 108, or a third-party service provider for storage. Developer server device(s) 108 may be associated with a developer and may for example, provide a decentralized application (e.g., dapp). Further, the developer in this context may own the user relationship directly with the end-consumers. Shard 2 is only used to recover the user's digital wallet. In 214, TEE 114 may perform additional sharding. In this example, Shard 3 is sharded into Shard 3a and Shard 3b. To reassemble Shard 3, both Shard 3a and Shard 3b would be required. Shard 3a may be stored, such as by platform server device 102 in a local storage device, cloud storage, or the like. Additionally, Shard 3a may be encrypted by the encryption context provided to TEE 114 in 204. Additionally, Shard 3b may be returned to the developer server device(s) 108, user device 110, or both, and used for day-to-day transactions. In some embodiments, everything that is created, aside from bits within TEE 114, may be returned and routed by platform server device 102.

### Exemplary Key Generation System and Architecture

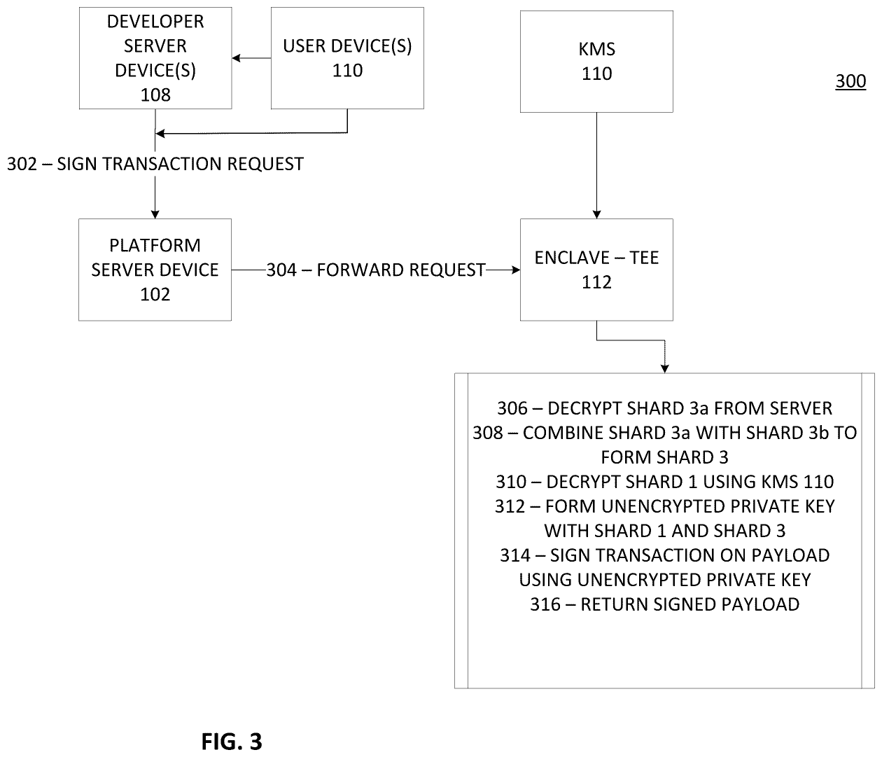

FIG. 3 illustrates a method 300 for signing a transaction using a trusted execution environment (TEE). In FIG. 3, the communicating elements include developer server device(s) 108, a user logged in to user device(s) 110, platform server device 102, KMS device 110, and TEE 114. A request 302 to have a transaction signed may be transmitted from the user device(s) 110 to platform server device 102. Additionally, or alternatively, request 302 may originate from developer server device(s) 108. In some embodiments, request 302 may be sent to platform server device 102 from user device 110 via developer server device(s) 108. Request 302 may include encryption context, such as a hashed user passcode (e.g., PIN), KMS instance data, network data (e.g., ETH_MAINNET), developer access shard (e.g., Shard 3b), and payload data (e.g., transaction to send to network). Server device 102 may forward 304 the request to TEE 114. In some embodiments, shards may be encrypted prior to storage and/or transmission to provide additional security. The forwarded request may include, for example, encryption context, such as the hashed user passcode (e.g., PIN that only the user knows) and network data (e.g., ETH_MAINNET).

After receiving the forwarded request, TEE 114 may decrypt 306 Shard 3a. Shard 3a may be decrypted, for example, using the encryption context data. TEE 114 may combine 308 Shard 3a with Shard 3b to form Shard 3. TEE 114 may use SSS to form Shard 3. Next, TEE 114 may decrypt 310 Shard 1 with KMS 112. Next, TEE 114 may form 312 the user's unencrypted private key using Shard 1 and Shard 3. In some embodiments, TEE 114 may use SSS to form the user's unencrypted private key. After the private key has been decrypted, TEE 114 may sign 314 the transaction on the payload. Finally, TEE 114 may return 316 the signed payload to platform server device 102.

### Exemplary Key Generation System and Architecture

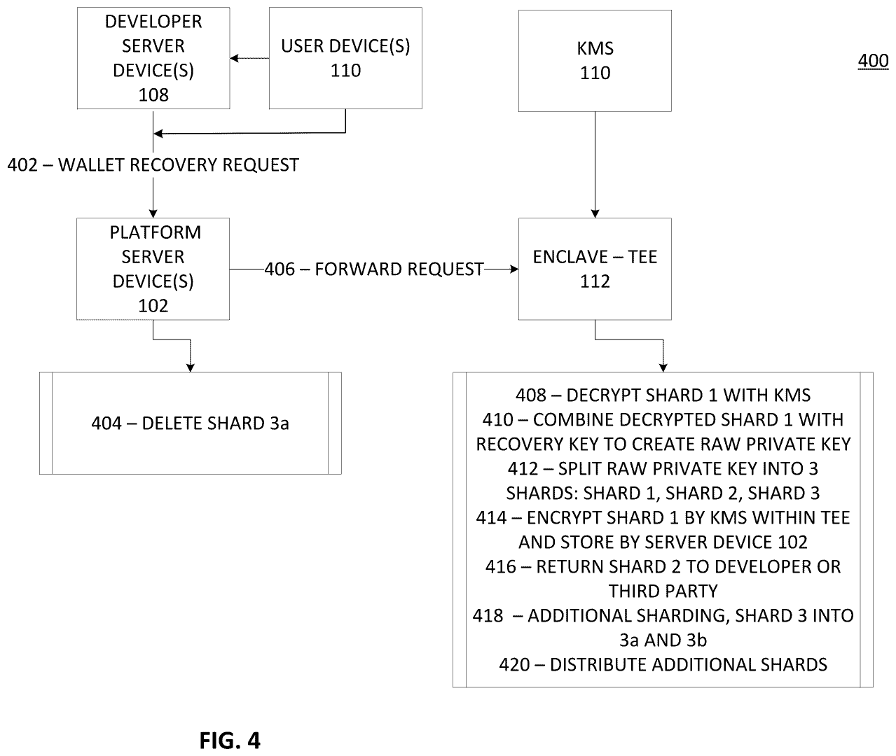

FIG. 4 illustrates a method 400 for digital wallet recovery using a trusted execution environment (TEE). In FIG. 4, the communicating elements include developer server device(s) 108, a user logged in to user device(s) 110, platform server device 102, KMS device 110, and TEE 114. A wallet recovery request 402 may be transmitted from the user device 110 to platform server device 102. Additionally, or alternatively, request 402 may originate from developer server device(s) 108. In some embodiments, request 402 may be sent to platform server device 102 from user device 110 via developer server device(s) 108. Request 402 may include a wallet ID (e.g., “wallet_id). In response to request 402, platform server device 102 may delete 404 Shard 3a associated with the wallet ID identified by the request. Deleting Shard 3a prevents future access to the wallet, such as via a signed transaction request or the like. Request 402 may include encryption context, such as a hashed user passcode (e.g., PIN), KMS instance data, and recovery key data (e.g., Shard 2). After Shard 3a is deleted, Server device 102 may forward 406 the request to TEE 114. The forwarded request may include, for example, Shard 1, encryption context, and recovery key data (e.g., Shard 2).

Within TEE 114, a wallet recovery process may be performed. TEE 114 may decrypt 408 Shard 1 using KMS 112. Next, TEE 114 may combine 410 decrypted Shard 1 with the recovery key (e.g., Shard 2) using SSS to create a raw private key. TEE 114 may then split 412 the raw private key into three shards using SSS, creating new Shards 1, 2, and 3. Two of the three shards will be needed to reassemble the private key. At 414, TEE 114 encrypts Shard 1 by KMS 112 within TEE 114. Shard 1 may be transmitted to and stored by platform server device 102. Platform server device 102 may store encrypted Shard 1 in a database, such as database 106, or within a secure cloud storage location. Shard 1 may be used, for example, to access the user's digital wallet for day-to-day transactions as well as for wallet recovery procedures. TEE 114 may transmit 416 Shard 2 to developer server device(s) 108, user device(s) 110, or a third-party service provider. In some embodiments, Shard 2 may be encrypted prior to transmission, storage, or both. Shard 2 is only used to recover the user's digital wallet. In 418, TEE 114 may perform additional sharding. In this example, Shard 3 is sharded into Shard 3a and Shard 3b. To reassemble Shard 3, both Shard 3a and Shard 3b would be required. Shard 3a may be encrypted and transmitted to platform server device 102 for storage, such as in a local storage device, cloud storage, or the like. Additionally, Shard 3a may be encrypted by the encryption context provided to TEE 114 in 406. Additionally, Shard 3b may be returned 420 to the developer server device(s) 108, user device(s) 110, or both, and used for day-to-day transactions.

### Exemplary Electronic Computing Device

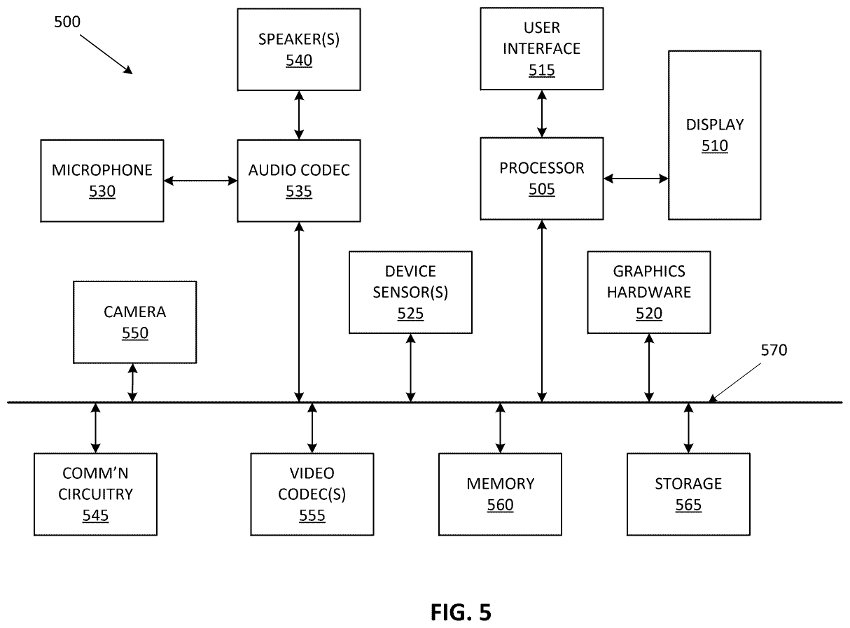

Referring now to FIG. 5 illustrates a simplified functional block diagram of illustrative programmable electronic computing device 500 is shown according to one embodiment. Electronic device 500 may be, for example, a mobile device (e.g., a cell phone), personal media device, portable camera, a tablet PC, laptop, desktop computer system, or the like. As shown, electronic device 500 may include processor 505, display 510, user interface 515, graphics hardware 520, device sensor(s) 525 (e.g., proximity sensor/ambient light sensor, gyroscope, etc.), microphone input 530, audio codec(s) 535, speaker(s) 540, communications circuitry 545, camera 550, video codec(s) 555, memory 560, storage 565, and communications bus 570.

Processor 505 may execute instructions necessary to conduct or control the operation of many functions performed by electronic device 500. Processor 505 may, for example, drive display 510 and receive user input from user interface 515. User interface 515 can take a variety of forms, such as a button, keypad, dial, a click wheel, keyboard, display screen and/or a touch screen. User interface 515 could, for example, be the conduit through which a user may initiate digital wallet generation, conduct transactions via their digital wallet, or recover their digital wallet. Processor 505 may be a system-on-chip (SOC) such as those found in mobile devices and include one or more dedicated graphics processing units (GPUs). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 perform computational tasks. In one embodiment, graphics hardware 520 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as a neural engine processing core.

Memory device 560 may include one or more different types of media used by processor 505 and/or graphics hardware 520 to perform device functions. For example, memory 560 may include memory cache, read-only memory (ROM), and/or random-access memory (RAM). Storage 565 may store media (e.g., audio, image and video files), computer program instructions or software, preference information, device profile information, and any other suitable data. Storage 565 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may comprise a non-volatile computer-readable medium that may be used to store computer program instructions or code organized into one or more modules and written in any desired computer programming language. When executed by, for example, processor 505, such computer program code may implement one or more of the methods, operations, or processes described herein.

### ADDITIONAL CONSIDERATIONS

In some embodiments described herein, a key management system, or KMS, is provided. A KMS is a critical component in robust encryption architectures. It manages the lifecycle of cryptographic keys for devices and applications. A KMS may, for example, be used for key generation, storage and distribution, metadata management, tenant-specific keys, encryption and decryption, key rotation and revocation, and integration with applications.

The KMS generates cryptographic key pairs (public and private keys). These keys are secret pieces of information used for cryptographic operations like signing messages or encrypting data. The KMS securely stores keys and ensures their availability when needed. It also distributes keys to authorized users or applications. For each key, the KMS maintains metadata, including a key tag, version, and tenant identifier (if applicable). This metadata helps track and manage keys efficiently. In multi-tenant cloud environments, the KMS derives tenant-specific keys from a root key pair and associated metadata. These tenant keys ensure data confidentiality for different tenants. When data needs to be encrypted, the KMS uses the appropriate key. Similarly, during decryption, the correct key is used to transform ciphertext back into plaintext. The KMS periodically rotates keys to enhance security. If a key is compromised or no longer needed, it can be revoked. Applications interact with the KMS to request keys for encryption, decryption, or signing operations.

A Trusted Execution Environment (TEE) is a secure area within a processor where sensitive applications and processes can run. It is isolated from the Rich Execution Environment (REE), where the operating system (such as Android, IOS, Windows, or Linux) executes. TEEs are crucial for handling potentially sensitive information, such as mobile banking or health care services. They provide a secure enclave for executing trusted applications, ensuring data confidentiality and integrity. In a multicore processor, TEEs can be scheduled for execution on specific cores, allowing them to operate independently from the REE. For instance, a TEE scheduler can manage threads within the TEE, while a REE global scheduler handles threads in the REE. This separation ensures robust security and privacy for critical tasks while maintaining overall system performance.

Shamir's Secret Sharding (SSS) is a cryptographic technique that divides a secret into multiple shares and distributes them among participants. A trusted entity generates a secret value (e.g., an encryption key or password). The trusted entity chooses a threshold value (k) and the total number of shards (n). The trusted entity constructs a polynomial of degree k−1 with the secret as the constant term. Each participant receives a unique shard (x, y), where x is their identifier (1 to n), and y is the polynomial value at that point (y=f(x)). The trusted entity gives each participant their shard (x, y). No single shard reveals any information about the secret. To reconstruct the secret: collect at least k shards and use Lagrange interpolation to find the polynomial and compute the constant term (the secret). An adversary with fewer than k shares gains no information about the secret. Even if some shards are compromised, the secret remains secure. Shamir's Secret Sharding has applications in secure key management, data recovery, and access control. It ensures robustness and confidentiality while preventing single points of failure.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and it may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other, and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A method for generating a key within a trusted execution environment (TEE), the method comprising:
generating, within the TEE, a private key for a user in response to receiving a request to create a digital wallet from the user;
creating a first shard, a second shard, and a third shard based on the private key using a sharding algorithm;
encrypting the first shard; and
transmitting the second shard to a developer associated with the digital wallet.

2. The method of claim 1, further comprising:
creating a fourth shard and a fifth shard based on the third shard using the sharding algorithm;
encrypting the fourth shard; and
transmitting the fifth shard to the developer associated with the digital wallet.

3. The method of claim 2, further comprising:
digitally signing a transaction request within the TEE.

4. The method of claim 3, wherein digitally signing the transaction request further comprises:
receiving the transaction request;
decrypting the fourth shard;
forming the third shard using the sharding algorithm with the decrypted fourth shard and the fifth shard;
decrypting the first shard;
forming the private key in unencrypted form using the sharding algorithm with the decrypted first shard and the third shard; and
signing a payload of the transaction request using the unencrypted private key.

5. The method of claim 1, further comprising:
recovering the digital wallet within the TEE.

6. The method of claim 5, wherein recovering the digital wallet further comprises:
receiving a digital wallet recovery request;
decrypting the first shard; and
combining the decrypted first shard with the second shard using the sharding algorithm to create a raw private key.

7. The method of claim 6, wherein recovering the digital wallet further comprises:
creating a sixth shard, a seventh shard, and an eighth shard based on the raw private key using the sharding algorithm;
encrypting the sixth shard;
transmitting the seventh shard to the developer associated with the digital wallet;
creating a ninth shard and a tenth shard based on the eighth shard using the sharding algorithm;
encrypting the ninth shard; and
transmitting the tenth shard to the developer associated with the digital wallet.

8. A device, comprising:
a memory; and
one or more processors comprising a trusted execution environment (TEE), wherein the one or more processors are configured to cause performance of operations, comprising:
generating, within the TEE, a private key for a user in response to receiving a request to create a digital wallet from the user;
creating a first shard, a second shard, and a third shard based on the private key using a sharding algorithm;
encrypting the first shard; and
transmitting the second shard to a developer associated with the digital wallet.

9. The device of claim 8, wherein the operations further comprise:
creating a fourth shard and a fifth shard based on the third shard using the sharding algorithm;
encrypting the fourth shard; and
transmitting the fifth shard to the developer associated with the digital wallet.

10. The device of claim 9, wherein the operations further comprise:
digitally signing a transaction request within the TEE.

11. The device of claim 10, wherein digitally signing the transaction request further comprises:
receiving the transaction request;
decrypting the fourth shard;
forming the third shard using the sharding algorithm with the decrypted fourth shard and the fifth shard;
decrypting the first shard;
forming the private key in unencrypted form using the sharding algorithm with the decrypted first shard and the third shard; and
signing a payload of the transaction request using the unencrypted private key.

12. The device of claim 8, wherein the operations further comprise:
recovering the digital wallet within the TEE.

13. The device of claim 12, wherein recovering the digital wallet further comprises:
receiving a digital wallet recovery request;
decrypting the first shard; and
combining the decrypted first shard with the second shard using the sharding algorithm to create a raw private key.

14. The device of claim 13, wherein recovering the digital wallet further comprises:
creating a sixth shard, a seventh shard, and an eighth shard based on the raw private key using the sharding algorithm;
encrypting the sixth shard;
transmitting the seventh shard to the developer associated with the digital wallet;
creating a ninth shard and a tenth shard based on the eighth shard using the sharding algorithm;
encrypting the ninth shard; and
transmitting the tenth shard to the developer associated with the digital wallet.

15. A non-volatile computer-readable medium that stores instructions that, when executed, cause performance of operations, comprising:
generating, within a trusted execution environment (TEE) of a processor, a private key for a user in response to receiving a request to create a digital wallet from the user;
creating a first shard, a second shard, and a third shard based on the private key using a sharding algorithm;
encrypting the first shard; and
transmitting the second shard to a developer associated with the digital wallet.

16. The non-volatile computer-readable medium of claim 15, wherein the operations further comprise:
creating a fourth shard and a fifth shard based on the third shard using the sharding algorithm;
encrypting the fourth shard; and
transmitting the fifth shard to the developer associated with the digital wallet.

17. The non-volatile computer-readable medium of claim 16, wherein the operations further comprise:
digitally signing a transaction request within the TEE.

18. The non-volatile computer-readable medium of claim 17, wherein digitally signing the transaction request further comprises:
receiving the transaction request;
decrypting the fourth shard;
forming the third shard using the sharding algorithm with the decrypted fourth shard and the fifth shard;
decrypting the first shard;
forming the private key in unencrypted form using the sharding algorithm with the decrypted first shard and the third shard; and
signing a payload of the transaction request using the unencrypted private key.

19. The non-volatile computer-readable medium of claim 15, wherein the operations further comprise:
recovering the digital wallet within the TEE.

20. The non-volatile computer-readable medium of claim 19, wherein recovering the digital wallet further comprises:
receiving a digital wallet recovery request;
decrypting the first shard;
combining the decrypted first shard with the second shard using the sharding algorithm to create a raw private key;
creating a sixth shard, a seventh shard, and an eighth shard based on the raw private key using the sharding algorithm;
encrypting the sixth shard;
transmitting the seventh shard to the developer associated with the digital wallet;
creating a ninth shard and a tenth shard based on the eighth shard using the sharding algorithm;
encrypting the ninth shard; and
transmitting the tenth shard to the developer associated with the digital wallet.
